(19) United States
(12) Patent Application Publication
(10) Pub. No.: US 2012/0173185 A1
(43) Pub. Date: Jul. 5, 2012

(54) SYSTEMS AND METHODS FOR EVALUATING RANGE SENSOR CALIBRATION DATA

(75) Inventors: Michael Allen TAYLOR, Pittsburgh, PA (US); Sudhir Katta, Pittsburgh, PA (US); Bradley Scott Kriel, Pittsburgh, PA (US)

(73) Assignee: Caterpillar Inc.

(21) Appl. No.: 12/982,079

(22) Filed: Dec. 30, 2010

(51) Int. Cl. G01J 1/10; G06F 19/00

(52) U.S. Cl. 702/104; 356/243.1

(57) ABSTRACT

In one embodiment, a method for evaluating calibration data collected by a range sensor of a mobile machine on a site includes collecting a calibration data set using the range sensor. The calibration data set includes information indicating the locations of a plurality of points on a surface of the site relative to the range sensor. The method further includes determining an expected error score of the calibration data set. Finally, the method includes determining whether to use the calibration data set to calibrate the range sensor based on the expected error score.

### TECHNICAL FIELD

This disclosure relates generally to systems and methods for calibrating a range sensor system. More particularly, the disclosure relates to systems and methods for evaluating data collected by a range sensor for use in calibrating the range sensor.

### BACKGROUND

Certain mobile machines are equipped with range sensors, such as Light Detection and Ranging (LIDAR) devices, stereo vision devices, or laser range scanners. A range sensor collects data regarding the range and direction from itself to points in the surrounding environment, which is used by the machine in navigation, mapping, and other applications. For example, an autonomous mine truck may have one or more range sensors used by an onboard computer for navigating the truck, performing mining-related tasks, detecting obstacles on the site, and avoiding collisions with other machines in the area.

For the information collected by a range sensor to be useful in such applications, the points must be mapped to their locations in the “real” world. Specifically, the coordinates of the points in a coordinate system associated with the range sensor must be transformed to their coordinates in a coordinate system associated with the machine. And the coordinates of the points in the machine coordinate system must then be transformed to their coordinates in a fixed coordinate system (i.e., the real world).

To perform this transformation, certain information must be known. For example, the location and orientation at which the range sensor is mounted on the machine must be known. The location and orientation of the machine in the world, which changes as the machine moves through the environment, must also be known. Moreover, the timing at which the range sensor determines the locations of the points in relation to the timing at which the navigation system of the machine determines the location and orientation of the machine must be known. In addition, the transformation does not produce results reliable enough for use in autonomous navigation, mapping, and other applications unless this information is known with a high level of accuracy. Thus, the transformation is highly susceptible to various types of error present in the system.

Techniques are known for calibrating a range sensor to mitigate error. Generally, calibrating a range sensor system involves using the range sensor to collect calibration data in an environment of known geometry, and then comparing the calibration data to the known geometry to determine a “misalignment” in the position and orientation of the range sensor on the machine. Once the misalignment is known, the range sensor can be calibrated by using the misalignment to correct the location of subsequent points collected by the range sensor. James P. Underwood et al., in Error Modeling and Calibration of Exteroceptive Sensors for Accurate Mapping Applications, Journal of Field Robotics 27(1) (February 2010) (“the Underwood article”), disclose methods for calibrating a range sensor in a autonomous ground vehicle navigation system or mapping system. Specifically, the Underwood article describes a method for calibrating a range sensor to mitigate error in the location of the points determined by the range sensor. This error can be due to poor sensor calibration; that is an error in the estimate of the relative location and orientation of the sensor to the machine, error in the navigation system's estimation of the position and orientation of the machine, and error in the time synchronization between the range sensor and the navigation system. Underwood explores ways to understand these source of error and develop the best estimate of the sensor's location and orientation relative to the machine in the presence of these errors.

While the method described in the Underwood article may be useful to calibrate a range sensor and reduce various types of error in an autonomous ground vehicle navigation system or mapping system, it may have certain drawbacks. This disclosure is directed to overcoming one or more problems in the art.

### SUMMARY

One aspect of the disclosure relates to a method for evaluating calibration data collected by a range sensor of a mobile machine on a site. The method may include collecting a calibration data set using the range sensor. The calibration data set may include information indicating the locations of a plurality of points on a surface of the site relative to the range sensor. The method may also include determining an expected error score of the calibration data set. Finally, the method may include determining whether to use the calibration data set to calibrate the range sensor based on the expected error score.

Another aspect of the disclosure relates to another method for evaluating calibration data collected by a range sensor of a mobile machine on a site. The method may include collecting a calibration data set using the range sensor. The calibration data set may include information indicating the locations of a plurality of points on a surface of the site relative to the range sensor. The method may further include determining an expected error score of the calibration data set, and then determining whether the expected error score of the calibration data set is above a threshold. Finally, the method may include alerting an operator of the mobile machine when it is determined that the expected error score of the calibration data set is above the threshold.

Yet another aspect of the disclosure relates to a system for evaluating calibration data collected by a range sensor of a mobile machine on a site. The system may include an operator interface and at least one range sensor configured to collect a calibration data set. The calibration data set may include information indicating the locations of a plurality of points on a surface of the site relative to the range sensor. The system may also include a sensor calibration computer. The computer may determine an expected error score of the calibration data set, and may determine whether the expected error score of the calibration data set is above a threshold. Finally, the computer may alert an operator of the mobile machine, via the operator interface, when it is determined that the expected error score of the calibration data set is above the threshold.

### BRIEF DESCRIPTION OF THE DRAWINGS

FIG. 1 is a representation of an exemplary site on which a mobile machine may operate, consistent with the disclosed embodiments;

FIG. 2 is a representation of exemplary coordinate frames involved in transforming the locations of points collected by a range sensor to their locations in the real world, consistent with the disclosed embodiments;

FIG. 3 is a representation of an exemplary sensor calibration environment, consistent with the disclosed embodiments;

FIGS. 4A and 4B show a representation of an exemplary calibration data set collected by the mobile machine, consistent with the disclosed embodiments;

FIG. 5 is a representation of an exemplary method for collecting sensor calibration data, consistent with the disclosed embodiments; and

FIG. 6 is a representation of an exemplary method for evaluating the calibration data set for use in calibrating the range sensor.

### DETAILED DESCRIPTION

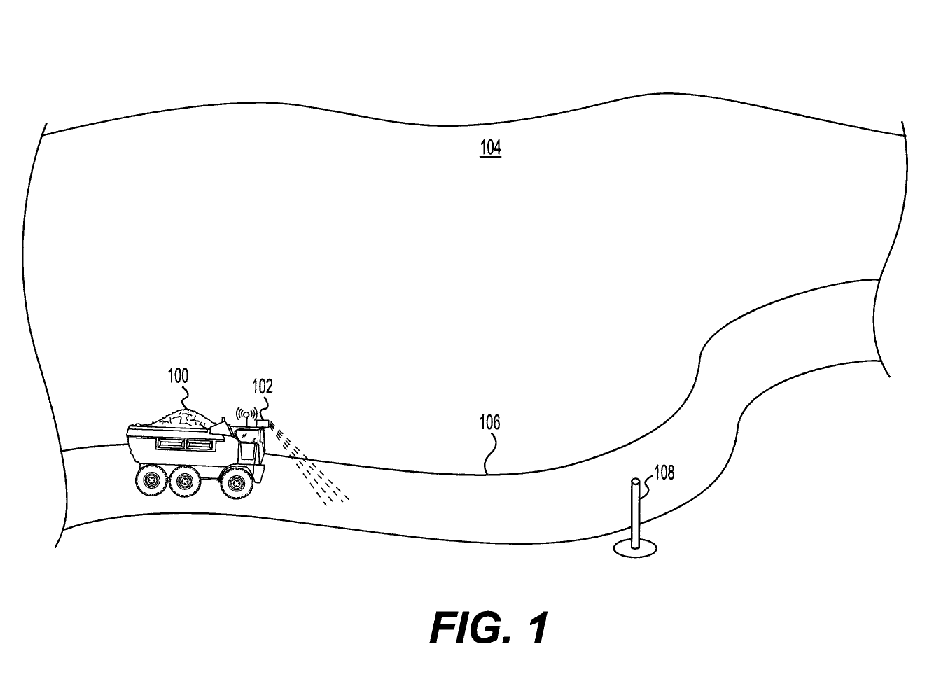

FIG. 1 illustrates an exemplary mobile machine 100. Mobile machine 100 may be an autonomous, semiautonomous, or operator-controlled machine or robot configured to perform some task associated with an industry, such as mining, construction, farming, freighting, transportation, or warfare. For example, as shown in FIG. 1, machine 100 may be haul truck configured to haul material in support of a mining operation. But it is contemplated that mobile machine 100 may embody a grader, a water truck, a dozer, a wheel loader, an exploratory vehicle, a passenger vehicle, or other type of mobile machine that performs a particular task.

Mobile machine 100 may have one or more range sensors 102 configured to gather sensor data about the environment surrounding machine 100, which machine 100 may use to perform various tasks. For example, range sensor 102 may be a machine “vision” device used in machine navigation, obstacle detection and avoidance, collision detection and avoidance, site mapping, material excavation or extraction, and/or applications. Accordingly, range sensor 102 may be a device configured to determine the range and direction from range sensor 102 to points on a surface within a field of view of range sensor 102 (i.e., “point cloud” data). Range sensor 102 may periodically or continuously output signals indicative of the determined range and direction to the points on the surface, and a time at which the range and direction to the points were determined. In one embodiment, range sensor 102 may include a Light Detection and Ranging (LIDAR) device, a Radio Detection and Ranging (RADAR) device, a camera device, a laser range scanner, a stereo vision device, or other type of range sensor known in the art. In other embodiments, instead of range sensor 102, a camera may be used.

To use the data gathered by range sensor 102 for applications such as controlling or navigating machine 100, mapping a site, detecting and avoiding obstacles, and/or detecting and avoiding collisions with other machines, the locations of the points determined by range sensor 102 generally must be transformed from the perspective of range sensor 102 to a “real world” perspective. That is, the locations of the points must be transformed from a coordinate frame associated with range sensor 102 to a coordinate frame associated with the real world.

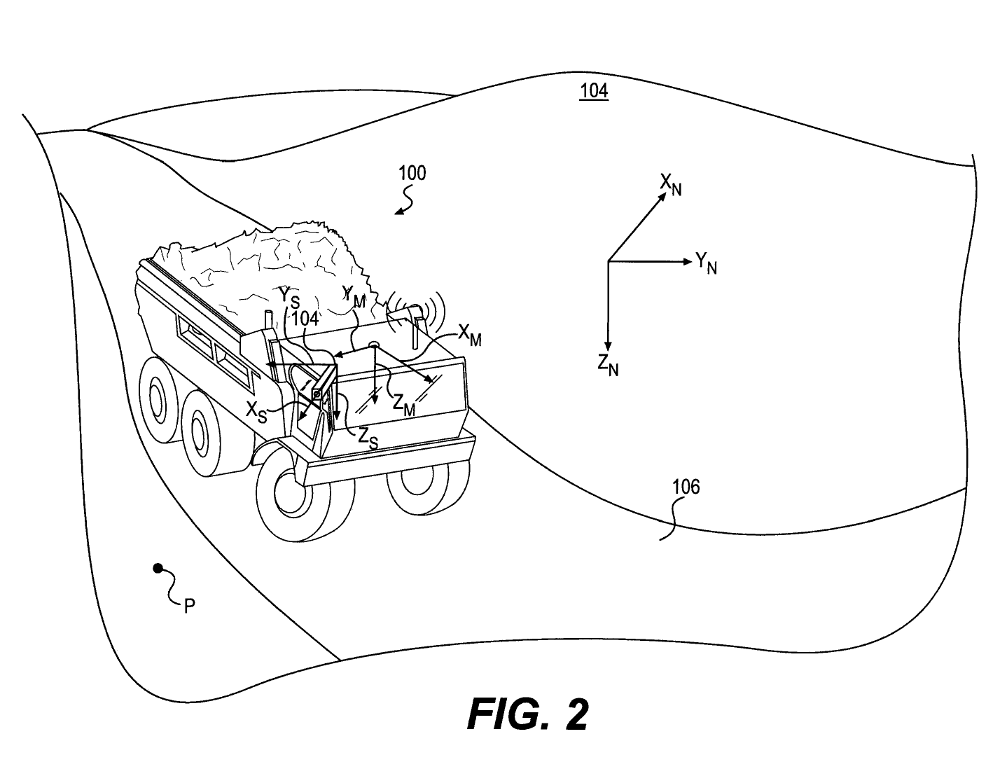

For example, as shown in FIG. 2, range sensor 102 may be associated with a sensor coordinate frame S having its origin fixed at the position range sensor 102 is mounted on machine 100 and aligned with a direction in which range sensor 102 is pointed. Accordingly, range sensor 102 may determine the location of points P on the surface in coordinates X_{S}, Y_{S}, and Z_{S} (or polar coordinates) of the sensor coordinate frame S. At the same time, since range sensor 102 is mounted on machine 100, sensor coordinate frame S may have a specific position offset (displacement) and orientation offset (roll, pitch, and yaw) from a machine coordinate frame M having its origin fixed at a certain point on machine 100 and aligned with the orientation of machine 102. Thus, the position of the points P with respect to machine 100 may depend upon the position and orientation offset of the sensor coordinate frame S from the machine coordinate frame M. Finally, since machine 100 travels in the real world, the machine coordinate frame M may have a specific position offset and orientation offset from a navigation coordinate frame N having its origin fixed at a certain point in the real world and aligned with a desired orientation, such as a cardinal direction. Thus, the position of the points P in the real world may depend upon the position (e.g., GPS location) and orientation (roll, pitch, and yaw) of machine 100 at the time the locations of the points P were determined by range sensor 102. As used hereinafter and as known in the art, “pose” refers to both a position and an orientation in a coordinate system.

Range sensor 102 may be calibrated to ensure the accuracy of sensor data for use in various applications. In one embodiment, shown in FIG. 1, a calibration site 104 may be used to gather and store sensor data for calibrating range sensor 102. For example, mobile machine 100 may travel, either autonomously or under operator control, along a predetermined calibration course 106 or other area of site 104 having terrain, features, or surface characteristics suitable for calibrating range sensor 102. In some embodiments, site 104 and/or calibration course 106 may include one or more calibration objects 108 easily distinguishable by range sensor 102 from the background of site 104—such as an upright pole or other distinct marker—which may improve the quality of the calibration data. Meanwhile, range sensor 102 may gather calibration data, as discussed above, to form a representation of at least a portion of site 100. In other embodiments, machine 100 may travel, either autonomously or under operator control, to one or more areas of interest on site 104. Upon arriving at such an area, machine 100 may stop, and range sensor 102 may gather calibration data for a period of time from that area.

After sufficient calibration data has been gathered and stored, range sensor 102 may be calibrated using known map information regarding site 104 and the stored calibration data. For example, using methods known in the art, the coordinates X_{S}, Y_{S}, and Z_{S} of the points P in the sensor coordinate frame S may be transformed to coordinates X_{M}, Y_{M}, and Z_{M} of the points P in the machine coordinate frame M. Then, the coordinates X_{M}, Y_{M}, and Z_{M} of the points P in the machine coordinate frame M may be transformed to coordinates X_{N}, Y_{N}, and Z_{N} of the points P in the navigation coordinate frame N. By comparing the coordinates X_{N}, Y_{N}, and Z_{N} of the points P in the navigation coordinate frame to a predetermined map of site 104, an offset pose of range sensor 102 can be determined. That is, the difference between the presumed orientation and position of range sensor 102 on machine 100 and the actual orientation and position of range sensor 104 on machine 100 (i.e., misalignment) can be determined. That is, the “true” offset (transformation) between the machine coordinate frame M and sensor coordinate frame S can be calculated.

Subsequently, data gathered by range sensor 102 for use in site mapping tasks, navigation tasks, and/or other tasks of machine 102 may be calibrated by adjusting the sensor data based on determined offset pose, thus improving the accuracy of the sensor data.

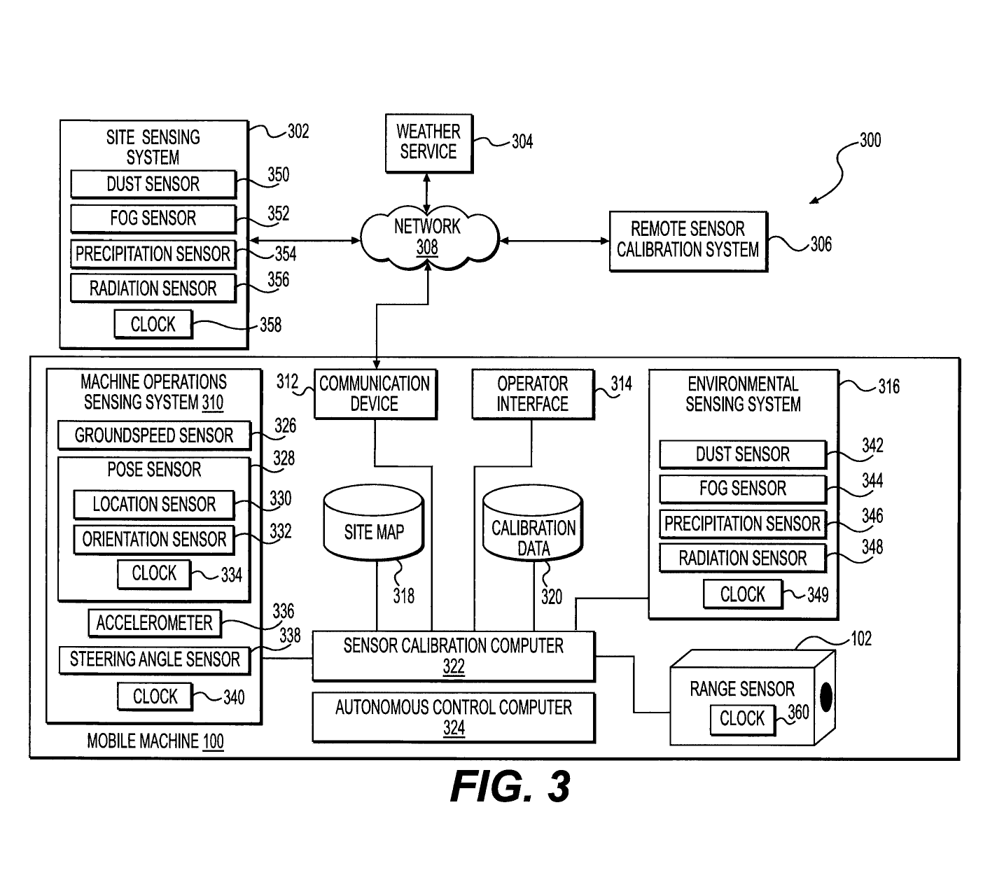

FIG. 3 illustrates an exemplary sensor calibration environment 300, consistent with the disclosed embodiments. Sensor calibration environment 300 may include one or more entities that, among other things, perform functions relating to the calibration of range sensor 102. For example, calibration environment 300 may include mobile machine 100 in communication with a site sensing system 302, a weather service 304, and/or a remote sensor calibration system 306 over a network 308. In general, sensor calibration environment 300 may evaluate a calibration data set collected by range sensor 102 to determine an expected error of the data set. Based on the expected error, environment 300 may determine whether to use the data set to calibrate range sensor 102 or to collect another calibration data set.

As shown in FIG. 3, mobile machine 100 may include a machine operations sensing system 310, a communication device 312, an operator interface 314, an environmental sensing system 316, range sensor 102, a site map repository 318, and/or a calibration data repository 320 in communication with a range sensor calibration computer 322. Mobile machine 100 may also optionally include an autonomous control computer 324.

Machine operations sensing system 310 may include one or more sensors and/or systems configured to sense different operational parameters associated with mobile machine 100. As discussed below, one or more of the sensed operational parameters may be used by calibration computer 322 to evaluate a calibration data set collected by range sensor 102 to determine an expected error of the data set.

Sensing system 310 may include a groundspeed sensor 326. Groundspeed sensor 326 may be configured to sense a rotational speed of one or more traction devices associated with machine 100, such as wheels, tracks, or treads. Based on the sensed rotational speed, groundspeed sensor 326 may output a signal indicative of the groundspeed of machine 100. But in other embodiments, groundspeed sensor 326 may be omitted and the groundspeed of machine 100 may be determined based on location sensor 330 (e.g., GPS). As discussed below, the sensed groundspeed of mobile machine 100, among other information, may be used to evaluate a calibration data set collected by range sensor 102 to determine an expected error of the data set. I

Sensing system 310 may also include a pose sensor 328. Pose sensor 328 may include one or more devices or systems configured to sense a pose of machine 100 in the real world. For example, pose sensor 328 may include a location sensor 330 configured to sense a location of machine 100 in the real world. Location sensor 330 may include, for example, a Global Positioning System (GPS), a Global Navigation Satellite System (GNSS), an Inertial Reference Unit (IRU), an odometric or dead-reckoning device, or any other device known in the art operable to determine a location of machine 100 in the real world. Location sensor 330 may output a signal indicative of the determined location of machine 100 in coordinates X_{N}, Y_{N}, and Z_{N} (or polar coordinates) of navigation coordinate frame N (FIG. 2).

Location sensor 330 may also output a signal corresponding to the mode of operation of location sensor 330, which may indicate an accuracy of the determined location of machine 100. For example, if location sensor 330 is a GPS or other satellite-based locating device, location sensor 330 may operate in one of several possible modes, depending on the quality of the received satellite signals, the number of satellites with which location sensor 330 is communicating, the type and/or quality of location sensor 330, and/or other factors. Possible modes of operation of location sensor 330 may include, for example, GPS Standalone mode, which is accurate to within 20 meters; Standard Differential GPS (DGPS) mode, which is accurate to within 3-5 meters; DGPS 2^{nd} Generation mode, which is accurate to within 1 meter; DGPS Precise Positioning Service (PPS) mode, which is accurate to within 0.5 meters; and/or DGPS Real Time Kinematic (RTK) mode, which is accurate to within several centimeters. In some embodiments, location sensor 320 may also operate in an error mode if the satellite signals are not available and/or cannot be detected, such as when the view of the sky is obstructed due to cloud cover or overhead structures.

Pose sensor 328 may also include an orientation sensor 332 configured to sense an orientation of machine 100 in the real world. For example, orientation sensor 332 may include an Inertial Measurement Unit (IMU), a laser tilt sensor, an inclination sensor, a radio direction finder, a gyrocompass, a fluxgate compass, and/or any other device known in the art operable to determine the relative roll, pitch, and yaw of machine 100 in the real world. Orientation sensor 332 may output a signal indicative of the determined roll, pitch, and yaw of machine 100. It is noted that the location of machine 100 determined by location sensor 330, and the roll, pitch, and yaw of machine 100 determined by orientation sensor 332, together, may represent the pose of machine 100 in the navigation coordinate frame N (FIG. 2).

Pose sensor 328 may further include a clock 334 configured to keep a time associated with pose sensor 328. For example, location sensor 330 may periodically receive signals from one or more GPS or GNSS satellites indicating a global time, and clock 334 may synchronize or update its time with the global time.

Based on the signals from location sensor 320, orientation sensor 332, and clock 334, pose sensor 328 may continuously or periodically output a signal indicative of the pose of machine 100 in the navigation frame N, the mode of operation of location sensor 330 at the time the location of mobile machine 100 was determined, and a time (i.e., time stamp) at which the pose of machine 100 was determined. As discussed below, the determined pose of machine 100—including the location, roll, pitch, and yaw of machine 100—may be used to evaluate a calibration data set collected by range sensor 102 to determine an expected error of the data set.

Sensing system 310 may also include an accelerometer 336. Accelerometer 336 may include any device configured to determine an acceleration of machine 100. For example, accelerometer 336 may determine a linear and/or angular acceleration of machine 100. Accelerometer 336 may generate a signal indicative of the determined acceleration of machine 100. As discussed below, the determined liner and/or angular acceleration, among other information, may be used to evaluate a calibration data set collected by range sensor 102 to determine an expected error of the data set.

Sensing system 310 may also include a steering angle sensor 338. Steering angle sensor 338 may include any device configured to determine a steering angle of machine 100 measured with respect to the heading of machine 100, and to generate a signal indicative of the determined steering angle of machine 100. The determined steering angle of machine 100, among other information, may be used to evaluate a calibration data set collected by range sensor 102 to determine an expected error of the data set.

Sensing system 310 may also include an associated clock 340. Clock 340 may keep a time associated with machine 100, and may generate a signal indicative of the determined time. The determined time may be appended as a time stamp to the determined ground speed, acceleration, and/or steering angle generated respectively by sensors 326, 336, and 338, to indicate the time at which these parameters were determined.

Communication device 312 may include any hardware and/or software components enabling mobile machine 100 to communicate with site sensing system 302, with weather service 304, with remote sensor calibration system 306, and/or with any other entities of environment 300 over network 308. For example, communication device 312 may include one or more modulators, demodulators, multiplexers, demultiplexers, transmitters, receivers, wireless devices, antennas, modems, or other devices configured to support two-way communication. Communication device 312 may communicate using satellite, cellular, infrared, radio, or other types of wireless communication signals.

Operator interface 314 may include any components or systems known in the art operable to receiving input from, and/or to provide output to, an operator of mobile machine 100. For example, operator interface 314 may include one or more display devices, monitors, warning lamps, indicators, touch-screens, keypads, keyboards, buttons, knobs, levers, joysticks, wheels, pedals, and/or other devices for providing input to systems of mobile machine 100 and/or for receiving output from systems of mobile machine 100.

Environmental sensing system 316 may include one or more devices configured to sense various environmental parameters at the location of mobile machine 100 on site 104. As described below, the sensed environmental parameters may be used to evaluate a calibration data set collected by range sensor 102 to determine an expected error of the data set.

For example, environmental sensing system 316 may include a dust sensor 342 configured to sense a dust level at the location of mobile machine 100 on site 104. Dust sensor 342 may generate and output a signal indicative of the sensed dust level. As described below, the sensed dust level, among other information, may be used to evaluate a calibration data set collected by range sensor 102 to determine an expected error of the data set.

Environmental sensing system 316 may further include a fog sensor 344 configured to sense a fog level at the location of mobile machine 100 on site 104. Fog sensor 344 may generate a signal indicative of the sensed fog level. As discussed below, the sensed fog level, among other information, may be used to evaluate a calibration data set collected by range sensor 102 to determine an expected error of the data set.

Environmental sensing system 316 may further include a precipitation sensor 346 configured to determine a rate of precipitation at the location of mobile machine 100 on site 104. Precipitation sensor 346 may generate a signal indicative of the determined rate of precipitation. As discussed below, the determined precipitation rate, among other information, may be used to evaluate a calibration data set collected by range sensor 102 to determine an expected error of the data set.

Environmental sensing system 316 may further include a radiation sensor 348 configured to determine an intensity of solar radiation at the location of mobile machine 100 on site 104. Radiation sensor 348 may generate a signal indicative of the determined solar radiation intensity. As discussed below, the determined solar radiation intensity, among other information, may be used to evaluate a calibration data set collected by range sensor 102 to determine an expected error of the data set.

In some embodiments, dust sensor 342, fog sensor 344, precipitation sensor 346, and/or radiation sensor 348 may be omitted, and the dust level, fog level, precipitation level, and/or radiation level may be determined using range sensor 102.

Environmental sensing system 316 may also include a clock 349. Clock 349 may keep a time associated with environmental sensing system 316, and may generate a signal indicative of the determined time. The determined time may be appended as a time stamp to the dust level, fog level, rate of precipitation, and/or solar radiation level determined respectively by sensors 342-348, to indicate the time at which these parameters were determined.

In other embodiments, site sensing system 302 may alternatively or additionally provide sensor calibration computer 322 and/or remote calibration system 306 with information indicative of environmental conditions on site 104 over network 308. For example, site sensing system 302 may also include one or more dust sensors 350, fog sensors 352, precipitation sensors 354, and/or radiation sensors 356 at different locations on site 104. Sensors 350-356 may periodically or continuously sense their respective environmental parameters at their locations on site 104, and may generate signals indicative of the sensed environmental parameters. The signals may be communicated to sensor calibration computer 322 and/or remote sensor calibration system 306 over network 308. Site sensing system 302 may also include a clock 358 configured to keep a time associated with site sensing system 302. Clock 358 may generate a signal indicative of the determined time. The determined time may be appended as a time stamp to the dust level, fog level, rate of precipitation, and/or solar radiation level determined respectively by sensors 350-356, to indicate the time at which these parameters were determined. Further, the location of sensors 350-356 (e.g., in site coordinate frame S) may be appended to the determined dust level, fog level, rate of precipitation, and/or solar radiation level, to indicate the locations on site 104 at which the environmental parameters were determined.

In a further embodiment, weather service 304 may alternatively or additionally provide sensor calibration computer 322 and/or remote calibration system 306 with information regarding the various environmental parameters over network 308. Weather service 304 may be, for example, an electronic weather reporting service configured to report weather information for one or more locations, including site 104, over network 308.

As discussed above in connection with FIG. 2, range sensor 102 may determine the range and direction to points P on the surface of site 104, relative to itself, in coordinates X_{S}, Y_{S}, and Z_{S} of the sensor coordinate frame S. Range sensor 102 may include a clock 360 configured to keep a time associated with range sensor 102. Range sensor 102 may append the time to the determined location of the points P on the surface of site 104. For example, range sensor 102 may continuously or periodically output signals containing the coordinates X_{S}, Y_{S}, and Z_{S} of the points P in the sensor coordinate frame S and containing the time, indicated by clock 360, at which range sensor 102 determined the locations of the points P.

Site map repository 318 may comprise any memory or other data storage device associated with sensor calibration computer 322. In one embodiment, site map repository 318 may contain one or more electronic maps defining the geometry of site 104. For example, site map repository 318 may include a matrix, a database, or other data storage structure storing points P on the surface of site 104 as coordinates X_{N}, Y_{N}, and Z_{N} in the navigation coordinate frame N. Site map repository 318 may be generated based on a survey of site 104, a mapping of site 104, and/or other known information regarding site 104.

Site map repository 318 may also contain information defining calibration course 106. For example, points P on the surface of site 104 that fall within calibration course 106 may be so designated in site map repository 318. Alternatively or additionally, site map repository 318 may define the outer bounds of calibration course 106, such as by designating one or more lines through points P on the perimeter of calibration course 106. It is to be appreciated that calibration course 106 may be specified or indicated in site map repository 318 in a variety of other ways, if desired.

Site map repository 318 may also designate one or more areas of interest on site 104 for calibrating range sensor 102. For example, site map repository 318 may define as calibration areas of interest points P on the surface of site 104 within a certain distance of calibration object 108. Any areas of interest on site 104 may be designated in site map repository 318 in a similar manner as calibration course 106 is designated in site map repository 318.

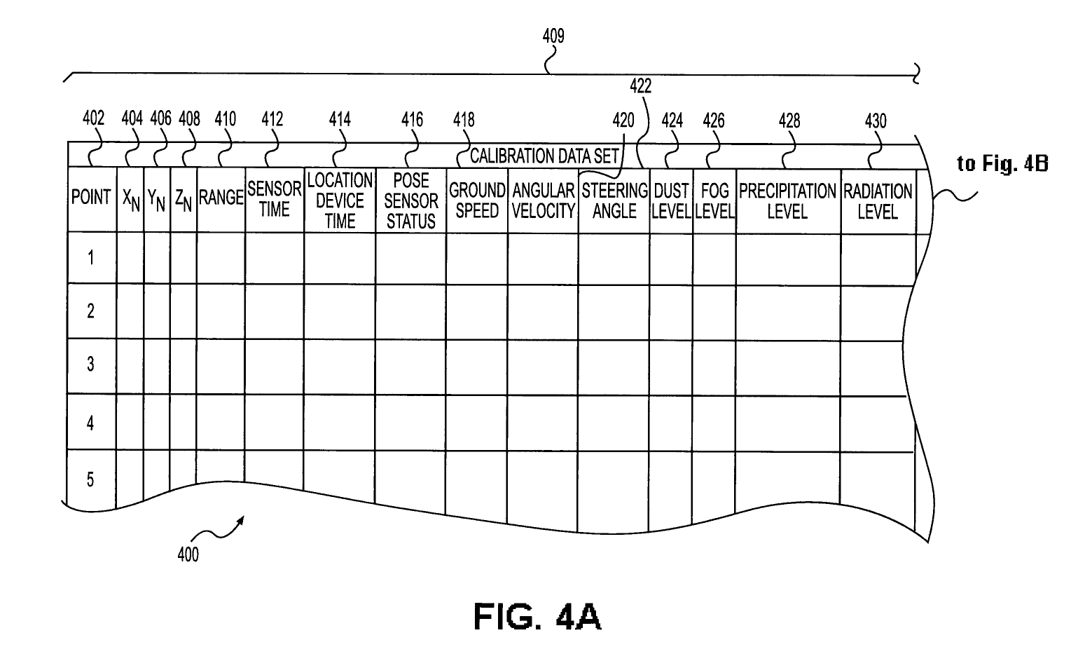

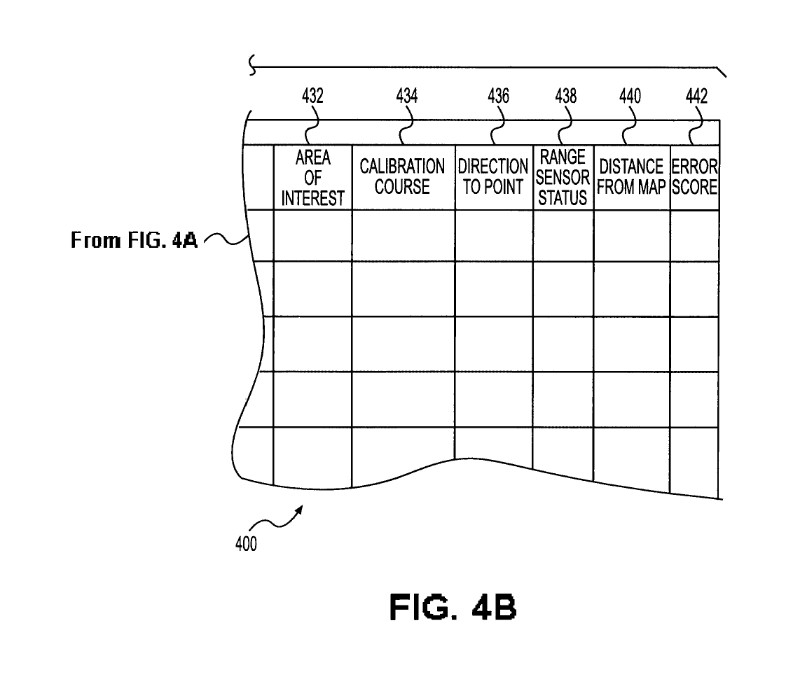

Calibration data repository 320 may comprise any memory or other data storage device associated with sensor calibration computer 322. Calibration data repository 320 may contain information regarding a calibration data set collected by range sensor 102. For example, FIGS. 4A and 4B illustrate a calibration data set 400 stored in calibration data repository 320. Calibration data set 400 may include a plurality of calibration data points 402 collected by range sensor 102. In one embodiment, for each calibration data point 402, calibration data table 400 may include a determined x-coordinate 404, a determined y-coordinate 406, and a determined z-coordinate 408 of the point 402 in the sensor coordinate frame S (or other desired coordinate frame).

Consistent with the disclosed embodiments, calibration data set 400 may include one or more calibration error factors 409 associated with each calibration data point 402. Error factors 409 may include any information useful to evaluate calibration data set 400 to determine an expected error calibration data set 400. For example, error factors 409 may include operational information associated with machine 100, environmental information associated with site 104, and/or other information that may be used to evaluate an expected error of calibration data set 400.

In one embodiment, error factors 409 may include a range 410 for each calibration data point 402. Range 410 may be a value indicating the distance (e.g., in meters) from range sensor 102 to the point 402 at the time range sensor 102 determined the location of the point 402. Range 410 may be used to determine an expected error of the point 402 for calibration purposes. For example, the accuracy of range sensor 102 may decrease as the distance from range sensor 102 to a point 402 increases.

Error factors 409 may also include a sensor time 412 associated with each calibration data point 402. Sensor time 412 may be the time indicated by range sensor clock 360 at the moment range sensor 102 determined the location of the point 402.

Error factors 409 may also include a location device time 414 for each calibration data point 402. Location device time 414 may be the time indicated by pose sensor clock 334 at the moment range sensor 102 determined the location of the point 402.

The difference between the sensor time 412 and the location device time 414 for a point 402 may correspond to an expected error of the point 402 for calibration purposes. Specifically, a difference in synchronization of the sensor time 412 and the location device time 414 may result in an error in the location of the point 402 in the machine coordinate frame M when transforming the location of the point 402 from the sensor coordinate frame S to the machine coordinate frame M. Moreover, this error may increase as the difference in synchronization of the sensor time 412 and the location device time 414 increases.

Error factors 409 may also include a pose sensor status 416 for each calibration data point 402. For example, pose sensor status 416 may indicate the mode in which pose sensor 328 was operating at the moment range sensor 102 determined the location of the point 402. Pose sensor status 416 may correspond to an expected error of the point 402 for calibration purposes. For example, in an embodiment where location sensor 330 is a GPS device, pose sensor status 416 may indicate the GPS mode in which the device was operating at the moment range sensor 102 determined the location of the point 402, such as Standard DGPS mode, PPS DGPS mode, RTK mode, no signal, or any other GPS device mode or state known in the art. Alternatively or additionally, pose sensor status 416 may indicate an expected accuracy, error, or tolerance of the determined location of mobile machine 100 at the time range sensor 102 determined the location of the point 402. For example, pose sensor status 416 may indicate an expected error of +/−50 cm in the determined location of machine 100, or may indicate that pose sensor 328 was operating in a low, medium, or high accuracy mode. An uncertainty or error in the determined pose of mobile machine 100 may result in an error in the location of the point 402 in the navigation coordinate frame N when transforming the location of the point 402 from the machine coordinate frame M to the navigation coordinate frame N. Moreover, this error may increase as the uncertainty or error in the determined pose of mobile machine 100 increases.

Error factors 409 may also include a range sensor status 438 for each calibration data point 402. Range sensor status 438 may indicate a status of range sensor 102 at the moment range sensor 102 determined location of the point 402. Range sensor status 438 may correspond to an expected error of the point 402 for calibration purposes. For example, range sensor status 438 may indicate whether range sensor 102 was outputting a signal, functioning properly, or operating in an error mode at the time. Range sensor status 438 may also indicate a noise level (e.g., low, medium, high) in the output signal.

Error factors 409 may also include a ground speed 418 associated with each calibration data point 402. Specifically, ground speed 418 may indicate the speed at which mobile machine 100 was traveling at the moment range sensor 102 determined the location of the point 402. The ground speed 418 of machine 100 at the time range sensor 102 determines the location of the point 402 may correspond to an expected error of the point 402 for calibration purposes. For example, the accuracy of range sensor 102 may decrease as the speed with which range sensor 402 moves through the environment increases.

Error factors 409 may also include an angular velocity 420 of mobile machine 100 for each calibration data point 402. Specifically, in one embodiment, angular velocity 420 may indicate a sensed magnitude and/or direction of the rate of change of the orientation (roll, pitch, and yaw) of mobile machine 100 at the time range sensor 102 determined the location of the point 402. The angular velocity 420 of machine 100 at the time range sensor 102 determines the location of the point 402 may correspond to an expected error of the point 402 for calibration purposes. For example, depending upon the direction range sensor 102 is pointed, the accuracy of range sensor 402 may decrease when range sensor 102 rolls, pitches, and/or yaws as machine 100 travels over uneven terrain on site 104. Further, the accuracy may decrease in proportion to the rate of the roll, pitch, and/or yaw.

Error factors 409 may also include a steering angle 422 associated with each calibration data point 402. Specifically, steering angle 422 may indicate the sensed steering angle of mobile machine 100 relative to the heading of mobile machine 100 at the time range sensor 102 determined the location of the point 402. The steering angle 422 of mobile machine 100 at the time range sensor 102 determines the location of the point 402 may correspond to an expected error of the point 402 for calibration purposes. For example, steering angle 422 and ground speed 418 of machine 100 correspond to roll, pitch, and/or yaw of machine 100 and range sensor 102. Thus, the accuracy of range sensor 102 may sometimes decrease as the steering angle 422 of machine 100 increases.

Moreover, error factors 409 may include a dust level 424, a fog level 426, a precipitation level 428, and/or a solar radiation level 430 sensed at the location of machine 100 at the time range sensor 102 determined the location of the point 402. In one embodiment, the sensed dust level 424, fog level 426, precipitation level 428, and/or solar radiation level 430 may be indicated as a magnitude within an overall range, such as low-high, 0%-100%, or 1-10.

The dust level 424 in the vicinity of machine 100 at the time range sensor 102 determines the location of the point 402 may correspond to an expected error of the point 402 for calibration purposes. Specifically, the accuracy of range sensor 102 may decrease as the dust level 424 increases. For example, a high level of dust may cause range sensor 102 to identify false points 402 that do not actually exist on the surface of site 104. Similarly, the fog level 426 and precipitation level 428 in the vicinity of machine 100 at the time range sensor 102 determines the location of the point 402 may correspond to an expected error of the point 402 for calibration purposes. Specifically, the accuracy of range sensor 102 may decrease as the fog level and/or rate of precipitation increases. For example, a high amount of fog and/or precipitation rate may also cause range sensor 102 to identify false points 402 that do not actually exist on the surface of site 104.

The solar radiation level 430 in the vicinity of machine 100 at the time range sensor 102 determines the location of the point 402 may also correspond to an expected error of the point 402 for calibration purposes. For example, if a laser-based range sensor 102 is employed, intense sunlight may decrease the accuracy of range sensor 102. On the other hand, if a camera-based range sensor 102 is employed, darkness or shade may decrease the accuracy of range sensor 102.

Error factors 409 may also include an area of interest indicator 432 associated with each calibration data point 402. In one embodiment, area of interest indicator 432 may indicate whether the point 402 is located in an area of interest on site 104, or located within a zone surrounding the area of interest. For example, area of interest indicator 432 may indicate whether the point 402 is located within a region surrounding calibration object 108. The area of interest indicator 432 may correspond to an expected error of the point 402 for calibration purposes. For example, as discussed above, range sensor 102 may sense more accurately points 402 in certain areas of site 104 that are suitable for gathering calibration data—such as areas including calibration object 108—than points 402 in other areas of site 104. In some embodiments, points 402 not located within an area of interest may be filtered or discarded.

Error factors 409 may also include a calibration course indicator 434 associated with each calibration data point 402. In one embodiment, calibration course indicator 434 may indicate whether machine 100 was traveling on calibration course 106, or within a zone surrounding calibration course 106, at the time range sensor 102 determined the location of the point 402. Calibration course indicator 434 may correspond to an expected error of the point 402 for calibration purposes. For example, site map 318 may contain more accurate data for areas of site 104 within the zone surrounding calibration course 106 than for areas outside the zone. Thus, range sensor 102 may be more accurately calibrated using points 402 falling within the zone than using points 402 falling outside the zone. In another example, site map 318 may contain no information for areas of site 104 outside the zone. Thus, points 402 falling outside the zone may be useless for calibrating range sensor 102. Accordingly, the degree to which the operator (or autonomous control computer 324) controls machine 100 to follow calibration course 106 may indicate the accuracy or quality of the points 402 for calibration purposes.

Error factors 409 may also include a direction 436 from range sensor 102 to each calibration data point 402. In one embodiment, direction 436 may indicate an angle from the direction in which range sensor 102 is pointed to the point 402 at the time range sensor 102 determined the location of the point 402. That is, direction 436 may indicate where the point 402 lies within the field of view of range sensor 102 at the time range sensor 102 determines the location of point 402. Direction 436 may also may correspond to an expected error of the point 402 for calibration purposes. For example, range sensor 102 may be more accurate with respect to points 402 located directly ahead of range sensor 102 than with respect to points 402 located to one side or the other of range sensor 102.

Error factors 409 may also include a distance 440 from a map associated with each calibration data point 402. In one embodiment, distance 440 may include a distance (e.g., in meters) from the point 402 to the nearest corresponding point contained in site map 318. Distance 440 from the map may indicate an expected error of the point 402 for calibration purposes. For example, a point 402 beyond a certain distance from a corresponding point contained in site map 318 may be erroneous or inaccurate. For example, a machine or other object on site 104 may have been blocking a portion of the field of view of range sensor 102 at the time range sensor 102 determined the location of the point 402.

Calibration data set 400 may also include an expected error score 442 for each calibration data point 402. Error score 442 may represent an overall expected error of the point 402. Error score 442 may be determined based on one or more of the error factors 409 for each point 402, and/or on other information. For example, error score 442 may be a value within a range (e.g., 1-10) indicating a magnitude of the expected error of the point 402 for calibration purposes, calculated based on one or more of the error factors 409. In another example, error score 442 may be a value (e.g., 1 or 0, yes or no, etc.) indicating whether the expected error of the point 402 is above a minimum error threshold, determined based on one or more of the error factors 409 for the point 402.

Sensor calibration computer 322 may embody a computing device onboard mobile machine 100. For example, sensor calibration computer 322 may include one or more computer processors (e.g., a CPU), memories (e.g., RAM, ROM, etc.), computer-readable data storage devices (e.g., a magnetic, electronic, or optical data storage device), data communications devices, and/or other computing elements that cooperate to perform the disclosed processes. For example, in one embodiment, sensor calibration computer 322 may include a designated onboard Electronic Control Module (ECM) configured to execute software or firmware instructions to perform the disclosed processes. In another embodiment, sensor calibration computer 322 may embody a laptop computer, a server computer, a mobile computing device, an onboard display computer, or other type of computer on machine 100 configured to perform the disclosed processes. In general, sensor calibration computer 322 may be configured to perform functions relating to collecting, storing, evaluating, and otherwise processing evaluating calibration data received from range sensor 102. In some embodiments, sensor calibration computer 322 may also be configured to perform functions relating to calibrating range sensor 102 using the calibration data.

Autonomous control computer 324 may also embody any type of computing device onboard mobile machine 100. Autonomous control computer 324 may be configured to provide instructions to systems of machine 100 to affect autonomous navigation, control, and/or other operations of machine 100.

Remote sensor calibration system 306 may include any computing system located remotely from machine 100. For example, remote sensor calibration system 306 may include a computing device or system of a business entity associated with machine 100 and/or with site 104. Remote sensor calibration system 306 may include one or more computer processors (e.g., a CPU), memories (e.g., RAM, ROM, etc.), computer-readable data storage devices (e.g., a magnetic, electronic, or optical data storage device), data communications devices, and/or other computing elements that cooperate to perform the disclosed processes. For example, remote sensor calibration system 306 may embody one or more server computers, distributed grid computers, laptop computers, desktop computers, mainframe computers, and/or other computing systems configured to perform the disclosed processes.

In general, in certain embodiments, remote sensor calibration system 306 may also be configured to perform functions relating to collecting, storing, evaluating, and otherwise processing calibration data received from range sensor 102. For example, in one embodiment, sensor calibration computer 322 may transmit or upload the collected calibration data to remote sensor calibration system 306 over network 308 for analysis. In another embodiment, sensor calibration computer 322 may continuously or periodically transmit to remote sensor calibration system 306 over network 308 the calibration data points collected by range sensor 102, the machine operations information collected by machine operations sensing system 310, and/or the environmental information collected by environmental sensing system 316. Alternatively or additionally, remote sensor calibration system 306 may receive the environmental information from site sensing system 302 and/or from weather service 304. Remote sensor calibration system 306 may then use the received information to evaluate the calibration data and/or to calibrate range sensor 102 using the calibration data.

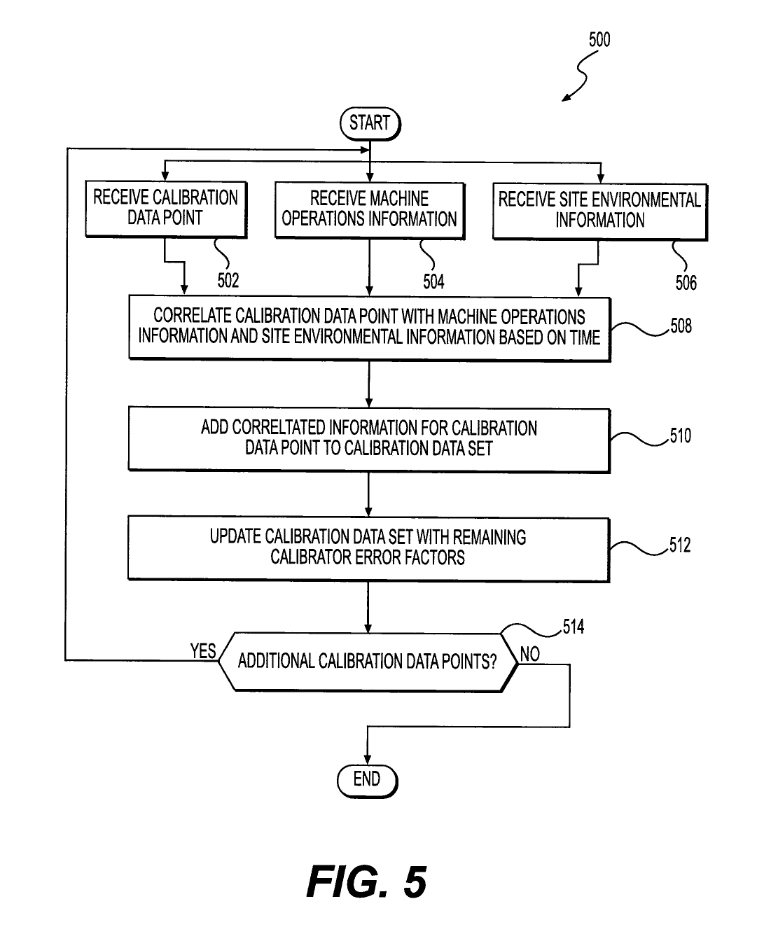

FIG. 5 illustrates an exemplary method 500 for collecting a calibration data set 400. Generally, method 500 may include receiving information regarding calibration data points P from range sensor 102, from machine operations sensing system 310, from environmental sensing system 316, from site sensing system 302, and/or from weather service 304. The method 500 may also include correlating the received information to create calibration data set 400. In one embodiment, method 500 may be performed by sensor calibration computer 322. In other embodiments, however, one or more steps of method 500 may alternatively or additionally be performed by remote sensor calibration system 306.

In step 502, sensor calibration computer 322 may receive a calibration data point P from range sensor 202. For example, the operator of machine 100 may control machine 100 to travel to a starting point of calibration course 106. The operator may then initiate sensor calibration computer 322 and/or range sensor 102 for data collection, and may control machine 100 to proceed along calibration course 104. Alternatively, autonomous control computer 324, in combination with sensor calibration computer 322, may control machine 100 to do the same.

Thereafter, range sensor 102 may begin collecting calibration data points P on the surface of site 104 and outputting signals indicative thereof. For example, as machine 100 travels down calibration course 106, range sensor 102 may begin outputting signals containing the coordinates X_{S}, Y_{S}, Z_{S} of the point P in the sensor coordinate frame S, the time indicated by range sensor clock 360 at the moment the location of the point P was determined, and a status of the range sensor 102 at the moment the location of the point P was determined.

Meanwhile, in step 504, sensor calibration computer 322 may receive machine operations information from machine operations sensing system 310. For example, sensor calibration computer 322 may receive from sensing system 310 one or more signals indicating the determined groundspeed of machine 100, the angular velocity of machine 100, the steering angle of machine 100, the pose (location and orientation) of machine 100, and the time at which these parameters were determined by machine operations sensing system 310.

In addition, in step 506, sensor calibration computer 322 may receive environmental information associated with site 104 from machine environmental sensing system 316. Alternatively or additionally, sensor calibration computer 322 may receive the environmental information from site sensing system 302 and/or from weather service 304. For example, sensor calibration computer 322 may receive one or more signals indicative of the dust level, the fog level, the rate of precipitation, and/or the solar radiation level at location of mobile machine 100 on site 104.

In step 508, sensor calibration computer 322 may correlate the calibration data point P received in step 502 with the machine operations information received in step 504 and the site environmental information received in step 506 based on time. For example, sensor calibration computer 322 may correlate the coordinates X_{S}, Y_{S}, Z_{S} of the calibration data point P in the sensor coordinate from S to the determined groundspeed, angular velocity, steering angle, and pose of machine 100 based on the time indicated by pose clock 334 (or machine operations sensing clock 340) and on the time indicated by range sensor clock 360. Sensor calibration computer 322 may also correlate the coordinates X_{S}, Y_{S}, Z_{S} of the calibration data point P to the determined dust level, the fog level, the rate of precipitation, and/or the solar radiation level at location of mobile machine 100 based on the time indicated by environmental sensing system clock 349 (or site sensing system clock 358) and on the time indicated by range sensor clock 360. In other words, in step 508, sensor calibration computer 322 may associate or “tag” the calibration data point P with the groundspeed, angular velocity, steering angle, and pose of machine 100, as well as with the dust level, the fog level, the rate of precipitation, and/or the solar radiation level at the location of machine 100.

In step 510, sensor calibration computer 322 may add the correlated information for the calibration data point P to the calibration data set 400. For example, sensor calibration computer 322 may add to calibration data set 400 a new point 402 corresponding to the calibration data point P. In addition, using the correlated information for the calibration data point P, sensor calibration computer 322 may add to calibration data set 400 the x-coordinate 404, y-coordinate 406, and z-coordinate 408 of the new point 402. Sensor calibration computer 322 may also add to calibration data set 400 the range sensor time 412, location device time 414, location sensor status 416, machine groundspeed 418, angular velocity 420, steering angle 422, dust level 424, fog level 426, precipitation level 428, solar radiation level 430, and range sensor status 438 for the new point 402.

In step 512, sensor calibration computer 322 may update calibration data set 400 with any remaining calibration error factors 409 for the calibration data point P. For example, based on the x-coordinate 404, y-coordinate 406, and z-coordinate 408 of the point 402, and on information contained in site map repository 318, sensor calibration computer 322 may determine whether the point 402 is within an area of interest on site 104. Sensor calibration computer 322 may then store an appropriate value for area of interest indicator 432 for the point 402 in calibration data set 400. Sensor calibration computer 322 may similarly determine whether machine 100 was on calibration course 106 at the time the location of point 402 was determined and store an appropriate value in calibration course indicator 434 for the point 402 in calibration data set 400. Sensor calibration computer 322 may also determine a range and direction from range sensor 102 to the point 402 at the time range sensor 102 determined the location of the point 401, and may store appropriate values for range 410 and direction 436 for the point 402 in calibration data set 400. In addition, based on the x-coordinate 404, y-coordinate 406, and z-coordinate 408 for the point 402 and on site map 318, sensor calibration computer 322 may determine a distance from the point 402 to the map of site 104, and may store an appropriate value for distance 440 for the point 402 in calibration data set 400.

In step 514, calibration data computer 322 may determine whether there are any additional calibration data points P that require processing. For example, since processing the prior calibration data point P, range sensor 102, machine operation sensing system 310, and environmental sensing system 316 may have collected information regarding additional calibration data points P now stored in the memory of sensor calibration computer 322 and awaiting processing. If additional calibration data points P require processing, method 500 may return to step 508 and process the points P as described above. Otherwise, method 500 may end.

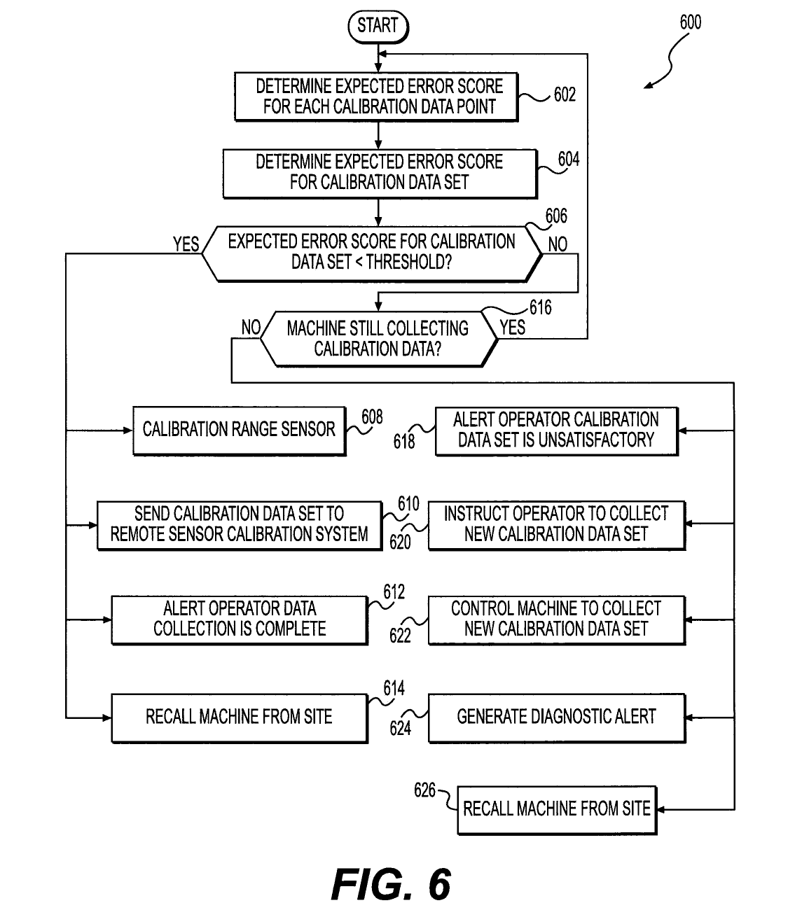

FIG. 6 illustrates an exemplary method 600 for evaluating calibration data set 400. In general, method 600 may determine an expected error of calibration data set 400 based on error factors 409, discussed above. If the expected error of calibration data set 400 is greater than a threshold, method 600 may determine that calibration data set 400 is unsatisfactory for use in calibrating range sensor 102, and may respond with one or more appropriate actions. If the expected error of calibration data set 400 is not greater than the threshold, method 600 may determine that calibration data set 400 is satisfactory for use in calibrating range sensor 102, and may respond in one or more appropriate ways. While method 600 is described as performed by sensor calibration computer 322, in other embodiments, one or more steps of method 600 may alternatively or additionally be performed by remote sensor calibration system 306.

In step 602, sensor calibration computer 322 may determine an expected error score 442 for each calibration point 402. Specifically, sensor calibration computer 332 may determine the expected error score 442 based on one or more error factors 409 for the point 402. In one embodiment, expected error score 442 may indicate that the point 402 is satisfactory or unsatisfactory (i.e., erroneous or not erroneous) for use in calibrating range sensor 102.

Sensor calibration computer 322 may determine the expected error score 442 for the point 402 based on range 410. For example, if the range 410 is greater than a threshold (e.g., 20 meters), sensor calibration computer 322 may score the point 402 as unsatisfactory (i.e., erroneous) for use in calibrating range sensor 102.

Sensor calibration computer 322 may also determine the expected error score 442 based on the sensor time 412 and on the location device time 414 for the point 402. For example, if a difference in synchronization between the sensor time 412 and the location device time 414 for the point is greater than a threshold (e.g., 5 ms), sensor calibration computer 322 may score the point 402 as unsatisfactory for calibrating range sensor 102.

Sensor calibration computer 322 may also determine the expected error score 442 based on the pose sensor status 416 for the point 402. For example, if pose sensor status 416 for the point 402 indicates that the determined location, roll, pitch, and/or yaw of machine 100 may not have been accurate at the time the location of the point 402 was determined, sensor calibration computer 322 may score the point as unsatisfactory for calibrating range sensor 102. For example, if pose sensor status 416 indicates that the GPS was not operating in RTK mode or another highly accurate mode, the point 402 may be scored as unsatisfactory for use in calibrating range sensor 102.

Sensor calibration computer 322 may also determine the expected error score 442 based on the machine groundspeed 418 for the point 402. For example, if the machine groundspeed 418 for the point 402 is above a speed threshold (e.g., 10 kph), sensor calibration computer 322 may score the point 402 as unsatisfactory for calibrating range sensor 102.

Sensor calibration computer 322 may also determine the expected error score 442 based on the angular velocity 420 for the point 402. For example, if the angular velocity 420 for the point 402 is above a threshold (e.g., 2 degrees of roll, pitch, or yaw per second), sensor calibration computer 322 may score the point 402 as unsatisfactory for calibrating range sensor 102.

Sensor calibration computer 322 may also determine the expected error score 442 based on the machine steering angle 422 for the point 402. For example, if the machine steering angle 422 for the point 402 is above a threshold (e.g., 30 degrees left or right), sensor calibration computer 322 may score the point 402 as unsatisfactory for calibrating range sensor 102.

Sensor calibration computer 322 may also determine the expected error score 442 based on the dust level 424, fog level 426, precipitation level 428, or solar radiation level 430 for the point 402. For example, if the dust level 424, fog level 426, precipitation level 428, or solar radiation level 430 associated with the point 402 is above a threshold, sensor calibration computer 322 may score the point 402 as unsatisfactory for calibrating range sensor 102.

Sensor calibration computer 322 may also determine the expected error score 442 based the area of interest indicator 432 for the point 402. For example, if the area of interest indicator 432 for the point 402 indicates that point 402 is not located within an area of interest on site 104 for calibrating range sensor 102, or within a zone surrounding the area of interest, sensor calibration computer 322 may score the point 402 as unsatisfactory for calibrating range sensor 102. That is, the point 402 may be discarded entirely from the analysis.

Sensor calibration computer 322 may also determine the expected error score 442 based the calibration course indicator 434 for the point 402. For example, if calibration course indicator 434 indicates that machine 100 was not located on or within a zone surrounding calibration course 106 when the location of point 402 was determined, sensor calibration computer 322 may score the point 402 as unsatisfactory for calibrating range sensor 102.

Sensor calibration computer 322 may also determine the expected error score 442 based the direction 436 from range sensor 102 to the point 402. For example, if the direction 436 from range sensor 102 to the point 402 is greater than a threshold angle (e.g., 25 degrees), sensor calibration computer 322 may score the point 402 as unsatisfactory for calibrating range sensor 102.

Sensor calibration computer 322 may also determine the expected error score 442 based on the range sensor status 438 for the point 402. For example, if the status 438 of range sensor 102 at the time range sensor 102 determined the location of point 402 indicates that range sensor 102 was operating in an unreliable, defective, or inaccurate mode (e.g., offline, no signal, or error mode), sensor calibration computer 322 may score the point 402 as unsatisfactory for calibrating range sensor 102.

Finally, sensor calibration computer 322 may also determine the expected error score 442 based the distance 440 from the point 402 to the map of site 104. For example, if the distance 440 from the point 402 to the surface of the map of site 104 stored in site map repository 318 is greater than a threshold angle (e.g., 15 cm), such as if an object was blocking the field of view of range sensor 102, sensor calibration computer 322 may score the point 402 as unsatisfactory for calibrating range sensor 102.

Otherwise, sensor calibration computer 322 may score the point as satisfactory for use in calibrating range sensor 102. During or after scoring each point 402, calibration computer 322 may update error score 442 for the point 402 with the determined score (e.g., satisfactory/unsatisfactory).

In other embodiments, sensor calibration computer 322 may determine a numerical expected error score 442 for each point 402 by calculating an expected error sub-score for each error factor 409 and combining the expected error sub-scores to determine the expected error score 442 for the point 402. For example, sensor calibration computer 332 may calculate an expected error sub-score for each of the range 410, the difference in synchronization between the sensor time 412 and the location device time 414, the pose sensor status 416, the machine groundspeed 418, the machine angular velocity 420, the machine steering angle 442, the dust level 424, the fog level 426, the precipitation level 428, the solar radiation level 430, the area of interest indicator 432, the calibration course indicator 434, the direction 436 from range sensor 102, the range sensor status 438, and the distance 440 from the site map for the point 402. Sensor calibration computer 332 may then add these expected error sub-scores to determine the expected error score 442 for the point 402.

In some embodiments, sensor calibration computer 332 may also weigh each expected error sub-score, and may combine the weighted sub-scores to determine the overall expected error score 442 for the point 402. The expected error sub-scores may be weighed differently, depending upon the influence the error factors 409 to which they correspond have on causing range sensor 102 to indicate erroneous data. For example, low-quality or inaccurate machine location information received from location sensor 330 (e.g., bad GPS data) may have a greater effect on the accuracy of the determined location of a point 402 than a high machine groundspeed. Accordingly, the expected error sub-score for pose sensor status 416 may be weighed more heavily than the expected error sub-score for machine ground speed 418 in calculating the overall error score 442 for a point 402. As another example, whether a point 402 is located within an area of interest on site 104, or whether machine 100 was located on calibration course 106 at the time the location of the point 402 was determined, may be given a greater weight than the machine steering angle at the time the location of the point 402 was determined. One of ordinary skill in the art will appreciate that other methods of scoring and/or weighing the points 402 to determine a error score 442 are possible and within the scope of the disclosure.

In certain embodiments, if a point 402 has an expected error score 442 below a threshold, and is deemed unsatisfactory for use in calibrating range sensor 102, calibration computer 322 may store in calibration data repository 320 an indication of the reason(s) why the point 402 was determined to be unsatisfactory. For example, if location sensor 330 was not operating in RTK mode or another highly accurate mode when the location of the point 402 was determined, sensor calibration computer 322 may store an indication of “GPS error” or the like in calibration data repository 320 for the point 402. As another example, if the point 402 is determined unsatisfactory because the dust level 424, fog level 426, precipitation level 428, or solar radiation level 430 was above the threshold, sensor calibration computer 322 may respectively indicate “dust,” “fog,” “rain,” or “sun” in the calibration data repository 320. As a further example, if the point 402 is determined unsatisfactory because machine 100 was not located on calibration course 106, or because the point 402 is not located within an area of interest on site 104, sensor calibration computer 322 may respectively indicate “off of calibration course” or “outside area of interest” in calibration data repository 320.

In step 604, sensor calibration computer 322 may determine an expected error score for calibration data set 400. Specifically, sensor calibration computer 322 may determine the expected error score for calibration data set 400 based on the expected error scores 442 of all of the points 402 in calibration data set 400.

In one embodiment, sensor calibration computer 322 may add the individual expected error scores 442 of all the points 402 in calibration data set 400 to determine a total expected error score. The total expected error score may be used as the overall expected error score for calibration data set 400.

In another embodiment, sensor calibration computer 332 may weigh the expected error score 442 of each point 402. For example, points 402 with a high expected error score 442 (i.e., less erroneous) may be weighed more heavily than points 402 with a low expected error score 442 (e.g., more erroneous). The weighed expected error scores 442 may then be added to determine the overall expected error score for calibration data set 400.

In another embodiment, sensor calibration computer 322 may determine the overall expected error score of calibration data set 400 by calculating an average or median of the expected error scores 442 of the points 402. In another configuration, sensor calibration computer 322 may determine the overall expected error score of calibration data set 400 based on the total number of points 402 and on the average or median of the points scores 442 for the points 402. One of ordinary skill in the art will appreciate that other methods of calculating an expected error score for calibration data set 400 are possible and within the scope of the disclosure.

In step 606, sensor calibration computer 322 may determine whether the expected error score for calibration data set 400 determined in step 606 is less than a threshold. In other words, sensor calibration computer 322 may determine whether calibration data set 400 is satisfactory to calibrate range sensor 202. For example, in an embodiment where each point 402 is judged to be satisfactory or unsatisfactory for use in calibration, the threshold may be set to a total number of satisfactory points (e.g., 2 million points) required to calibrate range sensor 102 with a desired degree of accuracy. That is, sensor calibration computer 322 may determine whether the total number of satisfactory data points 402 in calibration data set 400 is above a threshold. In another embodiment, sensor calibration computer 322 may determine whether the average or median of the expected error scores 442 is above a threshold for at least a certain number of points. For example, sensor calibration computer 322 may determine that calibration data set 400 is satisfactory to calibrate range sensor 102 if the average error score 442 is at least 7 out of 10 and there are at least 2 million points 402 in calibration data set 400.

If it is determined in step 606 that the expected error score for calibration data set 400 is below the threshold (i.e., calibration data set 400 is satisfactory), sensor calibration computer 322 may respond in a variety of ways. In one embodiment, in step 608, sensor calibration computer 322 may calibrate range sensor 102. For example, using methods known in the art, sensor calibration computer 322 may compare the coordinates of the points 402 in calibration data set 400 to the map of site 104 stored in site map repository 318 to determine an offset pose of range sensor 102. Sensor calibration computer 322 may store the determined offset pose in memory, and may use the offset pose to adjust any subsequent sensor data collected by range sensor 102 in mapping tasks, navigation tasks, or other tasks involving range sensor 102, to improve the accuracy of the sensor data.

In some embodiments, before calibrating range sensor 102, sensor calibration computer 322 may filter calibration data set 400 based on the expected error scores 409 for the points 402. For example, sensor calibration computer 322 may remove from calibration data set 400 any point 402 having an expected error score 409 below a threshold, such that that point 402 is not used in the calibration of range sensor 102.

Alternatively or additionally, in step 610, sensor calibration computer 322 may send calibration data 400 to remote sensor calibration system 306 for calibration. For example, remote sensor calibration system 306 may have greater computing resources than sensor calibration computer 322, and may be better equipped to handle the computationally-intensive calibration process than sensor calibration computer 322. Accordingly, sensor calibration computer 322 may upload calibration data 400 to remote sensor calibration system 306 over network 308. Remote sensor calibration system 306 may use the uploaded calibration data 400 to calculate the pose offset of range sensor 102. Remote sensor calibration system 306 may then send the calculated pose offset to sensor calibration computer 322 over network 308. Subsequently, sensor calibration computer 322 may store the determined pose offset in memory, and may use the stored pose offset to adjust any subsequent sensor data collected by range sensor 102 in mapping tasks, navigation tasks, or other tasks involving range sensor 102, to improve the accuracy of the sensor data.

Alternatively or additionally, in step 612, sensor calibration computer 322 may alert the operator of machine 100 that the collection of sensor calibration data is compete. For example, sensor calibration computer 322 may display a message to the operator on a display device of operator interface 314 indicating that machine 100 has collected a satisfactory calibration data set 400. Alternatively or additionally, sensor calibration computer 322 may audibly alert the operator, using a speaker of operator interface 314, that machine 100 has collected a satisfactory calibration data set 400. For example, sensor calibration computer 322 may output a chime, tone, or other sound indicating that data collection is complete.

Alternatively or additionally, in step 614, sensor calibration computer 322 may recall machine 100 from site 104. For example, sensor calibration computer 322 may display a message to the operator indicating that machine 100 has collected a satisfactory calibration data set 400 and instructing the operator to return machine 100 to a service bay for calibration. In an autonomous control configuration, sensor calibration computer 322 may instruct autonomous control computer 324 to control machine 100 to return to the service bay. In this embodiment, remote sensor calibration system 306 may be housed at the service bay. Upon arriving at the service bay, a technician may run calibration software installed on remote sensor calibration system 306 that downloads calibration data 400 from machine 100 to remote sensor calibration system 306, that calculates the offset pose of range sensor 102, and that uploads the calculated offset pose to sensor calibration computer 322 on machine 100.

If it is determined in step 606 that the score for calibration data set 400 is above the threshold (i.e., calibration data set 400 is unsatisfactory), sensor calibration computer 322 may determine whether machine 100 is still collecting calibration data, in step 616. For example, in certain embodiments, steps of method 600 may be performed while machine 100 is still collecting calibration data and adding additional points 402 to calibration data set 400. In other embodiments, however, method 600 may not be performed until the data collection process (i.e., a data collection “run”) is complete.

If sensor calibration computer 322 determines in step 616 that machine 100 is no longer collecting calibration data, sensor calibration computer 322 may take one or more actions. For example, in one embodiment, sensor calibration computer 322 may alert the operator of machine 100 that the calibration data set 400 is unsatisfactory for calibrating range sensor 102, in step 618. For example, sensor calibration computer 322 may display a message to the operator on the display device of operator interface 314 indicating that calibration data set 400 is unsatisfactory.

In connection with step 618, sensor calibration computer 322 may also determine the reasons why calibration data set 400 failed step 606, that is, why the score for calibration data set 400 is above the threshold. Specifically, sensor calibration computer 322 may analyze information stored in calibration data repository 320 to determine which error factors 409 contributed to points 402 being deemed unsatisfactory for calibrating range sensor 102. For example, sensor calibration computer 322 may determine that 20% of points 402 are unsatisfactory because the operator was driving too fast (i.e., the machine groundspeed was too high), that 10% of points 402 are unsatisfactory because the operator strayed from calibration course 106, and/or that 15% of the points 402 are unsatisfactory because the GPS was not operating in RTK or another high-accuracy mode (indicated by pose sensor status 416). This information may also be conveyed to the operator in the message displayed on the display device. Alternatively or additionally, sensor calibration computer 322 may audibly alert the operator, using a chime, tone, or other sound, that calibration data set 400 is unsatisfactory for calibrating range sensor 102.

Alternatively or additionally, in step 620, sensor calibration computer 322 may instruct the operator of machine 100 to collect a new calibration data set 400. For example, sensor calibration computer 322 may display a message on the display device instructing the operator to return to the starting point of calibration course 106 and collect a new calibration data set 400. In one embodiment, the message may instruct the operator to collect the new calibration data set 400 in a manner that addresses the reasons that the first calibration data set 400 was deemed unsatisfactory. For example, the message may instruct the operator to drive more slowly, to follow calibration course 106, to drive on smoother terrain, and/or to make other changes in the next data collection run that may reduce the expected error score of the new calibration data set 400.

Alternatively, in an autonomous control embodiment, machine 100 may be controlled to collect a new calibration data set 400 (step 622). For example, sensor calibration computer 322 may instruct autonomous control computer 324 to control machine 100 to collect a second calibration data set 400.

Alternatively or additionally, in step 624, sensor calibration computer 322 may generate a diagnostic alert. For example, sensor calibration computer 322 may generate a diagnostic alert when machine 100 has been unable to collect a calibration data set 400 with an expected error score below the threshold after a certain number of attempts (e.g., 3 attempts). In another example, sensor calibration computer 322 may generate a diagnostic alert when the expected error score of the calibration data set 400 is above the threshold for a reason that cannot be corrected by collecting a new calibration data set 400. For example, sensor calibration computer 322 may generate a diagnostic alert if pose sensor 328 or range sensor 102 was in an error state during data collection (indicated by pose sensor status 416 and range sensor status 438, respectively).

Alternatively or additionally, in step 626, sensor calibration computer 322 may recall machine 100 from site 104 (step 626). For example, if machine 100 has been unable to collect a satisfactory calibration data set 400 after several attempts, sensor calibration computer 322 may display a message instructing the operator to return machine 100 to the service bay for maintenance. In an autonomous control embodiment, sensor calibration computer 322 may instruct autonomous control computer 324 to control machine 100 to return to the service bay. Upon arrival at the service bay, a technician may inspect machine 100 and perform any necessary maintenance or repairs.

In some embodiments, after step 614, sensor calibration computer 322 may perform an additional step to determine the overall suitability of calibration data set 400. For example, sensor calibration computer 322 may transform the data set 400 to the navigation coordinate frame N, if not already done so. Sensor calibration computer 322 may compare the transformed calibration data set 400 to a known “good” calibration data set, such as a previously collected calibration data set, to determine the entropy of the calibration data set 400. If the entropy is above a threshold, sensor calibration computer 322 may determine that the calibration data set 400 is unsatisfactory for use in calibration, and may perform one or more of steps 618-626 described above. Optionally, sensor calibration computer 322 may adjust the threshold used in step 606 to be more or less stringent.

In another embodiment, sensor calibration computer 322 may compare the calibration data set 400 to known geometry associated with site 104 (e.g., site map 318) to determine how closely the data set 400 agrees with the known geometry. For example, sensor calibration computer 322 may determine how “crisp” the image of calibration object 108 is in the calibration data set 400 or whether the image of the calibration object 108 is oriented correctly in the calibration date set 400. Alternatively or additionally, calibration computer 322 may compare a known, flat surface of the site map 104 to the image of that flat surface in the calibration data set 400 to determine how closely the image of the surface agrees with the site map 104. Based on the comparison, calibration computer 322 may judge the calibration data set 400 satisfactory or unsatisfactory for use in calibration, and may perform one or more of steps 618-626 described above. Optionally, sensor calibration computer 322 may adjust the threshold used in step 606 to be more or less stringent based on the comparison.

Network 308 may embody any communication medium that enables two-way communication between mobile machine 100, site sensing system 302, weather service 304, remote sensor calibration system 306, and/or any other entity associated with environment 300 For example, network 308 may include a wireless networking platform, such as a satellite communication system. Alternatively and/or additionally, network 308 may include one or more broadband communication platforms appropriate for communicatively coupling the entities of environment 300 such as, for example, cellular, Bluetooth, microwave, radio, infrared, point-to-point wireless, point-to-multipoint wireless, multipoint-to-multipoint wireless, or any other appropriate communication platform for networking a number of components. Although network 308 is illustrated as a wireless communication network, it is contemplated that network 308 may include wireline networks such as, for example, Ethernet, fiber optic, waveguide, or any other type of wired communication network.

### INDUSTRIAL APPLICABILITY

The disclosed systems and methods may be applicable to any mobile machine that uses a range sensor or camera device to determine the range and direction from the machine to points in the surrounding environment for navigation, autonomous control, mapping, collision avoidance, or other applications. The disclosed systems and methods may be particularly useful in situations where the range sensor should be calibrated before using the machine in such applications, such as after installing the range sensor and associated systems on the machine but before delivering the machine to a dealer, supplier, renter, or other customer. The disclosed systems and methods may also be useful when concern over drifting sensor mounts or machine maintenance may necessitate recalibration of the sensors.

The disclosed systems and methods enable evaluating a collected sensor calibration data set based on machine operations information, on environmental information associated with site at which the calibration data is collected, and/or on other factors, to determine an expected error score of the calibration data set. The expected error score of the calibration data set may indicate whether the calibration data set is satisfactory for use in calibrating the range sensor. By determining an expected error score of the calibration data set in advance of the computationally-intensive calibration process, and while the machine and other resources are still on the site, a new calibration data set can easily be collected, if necessary. After a suitable calibration data set has been collected, the range sensor may be calibrated by a computer on the machine, by a remote calibration system, or by a technician at an off-site facility. Regardless of how and when the range sensor is calibrated, however, one is assured that a suitable calibration data set has been collected while the machine and other necessary resources are still on-line and on-site. Accordingly, the time and expense associated with calibrating the range sensor may be reduced.

It will be apparent to those skilled in the art that various modifications and variations can be made to the methods and systems of the present disclosure. Other embodiments of the method and system will be apparent to those skilled in the art from consideration of the specification and practice of the method and system disclosed herein.

For example, although sensor calibration computer 322 may be described as performing certain functions, remote sensor calibration system 306 may alternatively perform such functions. In some embodiments, sensor calibration computer 322 may be omitted entirely, and the functions thereof may be performed by remote sensor calibration system 306. Similarly, although environmental sensing system 316 onboard machine 100 may be described as providing certain information to sensor calibration computer 322, site sensing system 302 and/or weather service 304 may alternatively or additionally provide such information to sensor calibration computer 322 and/or to remote sensor calibration system 306. In such embodiments, it is contemplated that certain elements or all of environmental sensing system 316 may be omitted. In addition, although this written description may only discuss the collection and evaluation of calibration data for a single range sensor 102, it is to be appreciated that the disclosed principles may easily be extended to any number of range sensors 102 without departing from the spirit and scope of the disclosure. Accordingly, it is intended that the specification and examples be considered as exemplary only, with a true scope of the disclosure being indicated by the following claims and their equivalents.

What is claimed is:

1. A method for evaluating calibration data collected by a range sensor of a mobile machine on a site, the method comprising:
collecting a calibration data set using the range sensor, the calibration data set including information indicating the locations of a plurality of points on a surface of the site relative to the range sensor;
determining an expected error score of the calibration data set; and
determining whether to use the calibration data set to calibrate the range sensor based on the expected error score.

2. The method of claim 1, further comprising:
receiving operational information associated with the machine; and
determining the expected error score of the calibration data set based on the received operational information.

3. The method of claim 2, wherein the operation information associated with the machine includes at least one of a time associated with the range sensor, a status of the range sensor, a pose of the mobile machine determined by a pose sensor, a time associated with the pose sensor, a status associated with the pose sensor, a ground speed of the mobile machine, and an angular velocity of the mobile machine at the time of collecting the calibration data set.

4. The method of claim 1, further comprising:
receiving environmental information associated with the site; and
determining the expected error score of the calibration data set based on the received environmental information.

5. The method of claim 4, wherein the received environmental information includes at least one of a dust level, a fog level, a rate of precipitation, and a solar radiation level at the location of the mobile machine on the site at the time of collecting the calibration data set.

6. The method of claim 1, further comprising determining the expected error score of the calibration data set based on at least one of:
whether the machine was located within a designated area of the site at the time of collecting the calibration data set;
whether the plurality of points are located within a designated area of the site;
a range from the range sensor to the plurality of points; and
a direction from the range sensor to the plurality of points.

7. The method of claim 1, wherein determining whether to use the calibration data set to calibrate the range sensor includes determining whether the expected error score is below a threshold.

8. The method of claim 1, further comprising, when it is determined not to use the calibration data set to calibrate the range sensor, performing at least one of the following:
alerting an operator of the mobile machine that the calibration data set is unsatisfactory;
instructing the operator of the mobile machine, or controlling the mobile machine, to collect a new calibration data set;
generating a diagnostic alert; and
instructing the operator of the mobile machine, or controlling the mobile machine, to return to a service bay.

9. The method of claim 1, further comprising, when it is determined to use the calibration data set to calibrate the range sensor, performing at least one of the following:
calibrating the range sensor using the calibration data set;
alerting an operator of the mobile machine that the calibration data set is satisfactory;
transmitting the calibration data set to a remote calibration system for calibration of the range sensor; and
instructing the operator of the mobile machine, or controlling the mobile machine, to return to a service bay for calibration of the range sensor.

10. A method for evaluating calibration data collected by a range sensor of a mobile machine on a site, the method comprising:
collecting a calibration data set using the range sensor, the calibration data set including information indicating the locations of a plurality of points on a surface of the site relative to the range sensor;
determining an expected error score of the calibration data set;
determining whether the expected error score of the calibration data set is above a threshold; and
alerting an operator of the mobile machine when it is determined that the expected error score of the calibration data set is above the threshold.

11. The method of claim 10, further comprising:
receiving operational information associated with the machine; and
determining the expected error score of the calibration data set based on the received operational information.

12. The method of claim 11, wherein the operation information associated with the machine includes at least one of a time associated with the range sensor, a status of the range sensor, a pose of the mobile machine determined by a pose sensor, a time associated with the pose sensor, a status associated with the pose sensor, a ground speed of the mobile machine, and an angular velocity of the mobile machine at the time of collecting the calibration data set.

13. The method of claim 10, further comprising:
receiving environmental information associated with the site; and
determining the expected error score of the calibration data set based on the received environmental information.

14. The method of claim 13, wherein the received environmental information includes at least one of a dust level, a fog level, a rate of precipitation, and a solar radiation level at the location of the mobile machine on the site at the time of collecting the calibration data set.

15. The method of claim 10, further comprising determining the expected error score of the calibration data set based on at least one of:
whether the machine was located within a designated area of the site at the time of collecting the calibration data set,
whether the plurality of points are located within a designated area of the site,
a range from the range sensor to the plurality of points, and
a direction from the range sensor to the plurality of points.

16. The method of claim 10, further comprising, when it is determined that the expected error score of the calibration data set is above the threshold, performing at least one of the following:
instructing the operator of the mobile machine, or controlling the mobile machine, to collect a new calibration data set;
alerting the operator of the mobile machine that the calibration data set is unsatisfactory;
generating a diagnostic alert; and
instructing the operator of the mobile machine, or controlling the mobile machine, to return to a service bay.

17. The method of claim 10, further comprising, when it is determined that the expected error score of the calibration data set is not above the threshold, performing at least one of the following:
calibrating the range sensor using the calibration data set;
alerting the operator of the mobile machine that the calibration data set is satisfactory;
transmitting the calibration data set to a remote calibration system for calibration of the range sensor; and
instructing the operator of the mobile machine, or controlling the mobile machine, to return to a service bay for calibration of the range sensor.

18. A system for evaluating calibration data collected by a range sensor of a mobile machine on a site, the system comprising:
an operator interface;
at least one range sensor configured to collect a calibration data set, the calibration data set including information indicating the locations of a plurality of points on a surface of the site relative to the range sensor; and
a sensor calibration computer configured to:
determine an expected error score of the calibration data set;
determine whether the expected error score of the calibration data set is above a threshold; and
alert an operator of the mobile machine, via the operator interface, when it is determined that the expected error score of the calibration data set is above the threshold.

19. The system of claim 18, further comprising:
a machine operations sensing system configured to sense operational information associated with the machine; and
an environmental sensing system configured to sense environmental information associated with the site,
wherein the sensor calibration computer is further configured to determine the expected error score of the calibration data set based on at least one of the machine operational information and on the environmental information.

20. The system of claim 19, wherein:
the machine operational information includes at least one of a time associated with the range sensor, a status of the range sensor, a pose of the mobile machine determined by a pose sensor, a time associated with the pose sensor, a status associated with the pose sensor, a ground speed of the mobile machine, and an angular velocity of the mobile machine at the time of collecting the calibration data set; and
the environmental information includes at least one of a dust level, a fog level, a rate of precipitation, and a solar radiation level at the location of the mobile machine on the site at the time of collecting the calibration data set.

21. The system of claim 18, further comprising a memory storing map information associated with the site, wherein the sensor calibration computer is further configured to:
determine, based on the map, at least one of whether the machine was located within a designated area of the site at the time of collecting the calibration data set, whether the plurality of points are located within a designated area of the site, a range from the range sensor to the plurality of points, and a direction from the range sensor to the plurality of points; and
determine the expected error score of the calibration data set based on at least one of whether the machine was located within a designated area of the site at the time of collecting the calibration data set, whether the plurality of points are located within a designated area of the site, a range from the range sensor to the plurality of points, and a direction from the range sensor to the plurality of points.

22. The system of claim 18, wherein the sensor calibration computer is further configured to perform at least one of the following when it is determined that the expected error score of the calibration data set is above the threshold:
instruct the operator of the mobile machine via the operator interface, or control the mobile machine, to collect a new calibration data set;
alert the operator of the mobile machine via the operator interface that the calibration data set is unsatisfactory;
provide a diagnostic alert via the operator interface; and
instruct the operator via the interface, or control the mobile machine, to return to a service bay.

23. The system of claim 18, wherein the sensor calibration computer is further configured to perform at least one of the following when it is determined that the expected error score of the calibration data set is not above the threshold:
calibrate the range sensor using the calibration data set;
alert the operator via the operator interface that the calibration data set is satisfactory;
transmit the calibration data set to a remote calibration system for calibration of the range sensor; and
instruct the operator via the interface, or control the mobile machine, to return to a service bay for calibration of the range sensor.
